(19) United States
(12) Patent Application Publication
(10) Pub. No.: US 2002/0076996 A1
(43) Pub. Date: Jun. 20, 2002

(54) Connector

(75) Inventors: Takao Murakami, Shizuoka (JP); Masaru Fukuda, Shizuoka (JP)

Correspondence Address: MORGAN LEWIS & BOCKIUS LLP, 1111 PENNSYLVANIA AVENUE NW, WASHINGTON, DC, 20004, US

(73) Assignee: Yazaki Corporation

(21) Appl. No.: 09/887,253

(22) Filed: Jun. 25, 2001

(30) Foreign Application Priority Data
Jul. 17, 2000 (JP) P. 2000-215777
Jun. 27, 2000 (JP) P. 2000-192483

(51) Int. Cl. H01R 13/40

(52) U.S. Cl. 439/752.5

(57) ABSTRACT

At least one pair of positioning members are provided on both side faces of a terminal fitting connected to an electric wire. A housing includes a chamber for accommodating the terminal fitting therein, and a pair of guide members engaged with the associated positioning members to guide the terminal fitting inserted into the chamber to a predetermined position. The positioning members are protrusions integrally formed with the both side walls of the terminal fitting. The guide members are a pair of grooves each formed on both side walls of the chamber for receiving the associated protrusions therein.

### BACKGROUND OF THE INVENTION

This invention relates to a connector, such as a waterproof connector, in which a wire, connected to a terminal received in a chamber in a connector housing, is sealed by a rubber plug.

FIG. 10 shows a related connector of the type described. This connector 1 comprises a housing 2 having chambers 3 for respectively receiving terminals 7 each press-clamping a wire 5 and a rubber plug 6. A cantilever-type elastic arm (so-called lance) 4 for retaining the terminal 7 is integrally formed on and projects upwardly from a bottom wall of the chamber 3.

When the terminal 7 is inserted into the chamber 3 in the housing 2 from the rear side thereof, the elastic arm 4 is elastically deformed, and retains the terminal 3 in the chamber 3. A lower portion of the terminal 7, retained in the chamber 3 by the elastic arm 4, is supported by a spacer 8, inserted into the chamber 3 from the front side thereof.

In the related connector 1, the terminal 7 is received in the chamber 3, and is retained therein by the elastic arm 4, and besides the terminal 7 is supported by the rattle-preventing spacer 8. However, since the clearance (Δd) of the terminal 7 is formed as a result of accumulation of dimensional irregularities (tolerances) of three dimensions, that is, a height A of the chamber 3 in the housing 2, a thickness C of the spacer 8 and a height B of the terminal 7 (Δd=A−C−B), it tends to be enlarged. As a result, there is probability that the durability of the terminal was adversely affected by vibrations and others.

### SUMMARY OF THE INVENTION

Therefore, this invention has been made in order to solve the above problem, and an object of the invention is to provide a connector in which the clearance of a terminal is suppressed so as to enhance the durability against vibrations and others.

In order to achieve the above object, according to the present invention, there is provided a connector comprising:

a terminal fitting, connected to an electric wire;

at least one pair of positioning members, provided on both side faces of the terminal fitting; and

a housing, including a chamber for accommodating the terminal fitting therein, and a pair of guide members engaged with the associated positioning members to guide the terminal fitting inserted into the chamber to a predetermined position.

In this configuration, the clearance of the terminal fitting within the chamber is suppressed, and the durability against vibrations and others is enhanced. Therefore, wear of that portion of the terminal, disposed in contact with a mating terminal, which would be caused by the clearance, is positively prevented, so that the contact reliability of the terminal is further enhanced.

Preferably, the positioning members are protrusions integrally formed with the both side walls of the terminal fitting, and the guide members are a pair of grooves each formed on both side walls of the chamber for receiving the associated protrusions therein.

In this configuration, the clearance of the terminal in the chamber is suppressed easily and positively with this simple construction, and the connector of a high reliability can be produced at low costs.

### BRIEF DESCRIPTION OF THE DRAWINGS

The above objects and advantages of the present invention will become more apparent by describing in detail preferred exemplary embodiments thereof with reference to the accompanying drawings, wherein like reference numerals designate like or corresponding parts throughout the several views, and wherein:

FIG. 1 is a vertical cross-sectional view of one preferred embodiment of a connector of the invention, showing a condition before this connector is assembled;

FIG. 2 is a vertical cross-sectional view of the connector, showing a condition in which an inner housing is provisionally fitted in an outer housing, with terminals not yet inserted;

FIG. 3 is a vertical cross-sectional view of the connector in the above provisionally-fitted condition, showing a condition during the insertion of the terminals;

FIG. 4 is a vertical cross-sectional view of the connector in the provisionally-fitted condition, showing a condition in which the terminals are primarily retained;

FIG. 5 is a vertical cross-sectional view of the connector in a completely-assembled condition in which the inner housing is completely fitted in the outer housing;

FIG. 6 is a front-elevational view of the connector in its completely-assembled condition;

FIG. 7 is a perspective view of the terminal to be received in a chamber in the inner housing, according to a first embodiment of the invention;

FIG. 8 is a cross-sectional view of the terminal of FIG. 7 in its received condition;

FIG. 9 is a perspective view of a terminal to be received in the chamber, according to a second embodiment of the invention;

FIG. 10 is a cross-sectional view of a related connector; and

FIG. 11 is a cross-sectional view showing a terminal in its received condition, which is used in the related connector.

### DETAILED DESCRIPTION OF THE PREFERRED EMBODIMENTS

One preferred embodiment of the present invention will now be described with reference to the drawings.

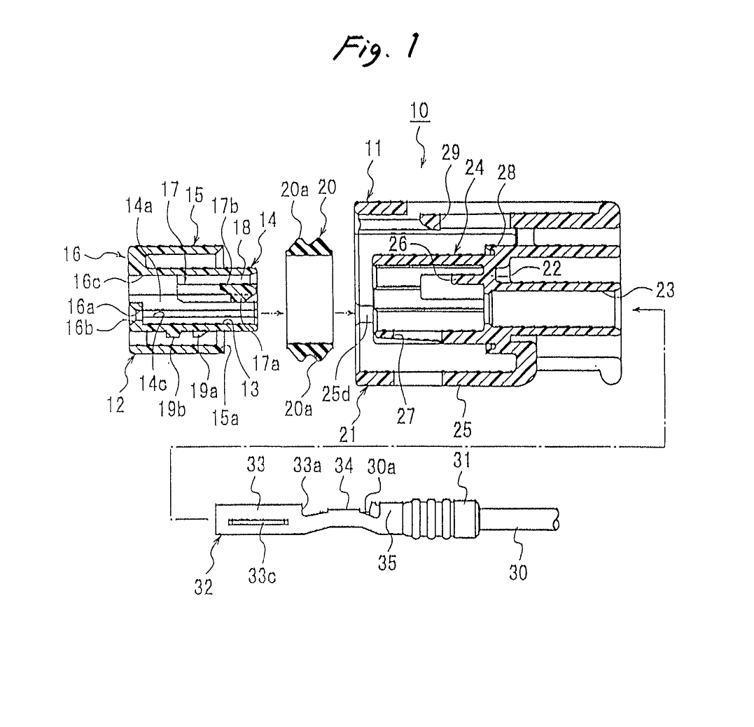

As shown in FIGS. 1 to 6, a connector housing 11 of the connector 10 comprises the inner housing 12, made of a synthetic resin, and the outer housing 21 of a synthetic resin to be fitted with the inner housing 12. The inner housing 12 has a pair of right and left chambers 13 formed integrally therewith for respectively receiving terminals 32 each press-clamping a wire 30 and a rubber plug 31. The outer housing 21 has a pair of right and left insertion paths 23 of a substantially cylindrical shape each formed integrally therewith for receiving the wire 30, the rubber plug 21 and the terminal 32. A waterproof packing 20 is provided between the inner housing 12 and the outer housing 21.

The inner housing 12 includes an inner peripheral wall portion 14 of a substantially square shape (having an open rear end) for fitting in an inner peripheral wall portion 24 of the outer housing 21, an outer peripheral wall portion 15 of a substantially square shape, which extends rearwardly in surrounding relation to the inner peripheral wall portion 14, and can be fitted on the inner peripheral wall portion 24 of the outer housing 21, and a front wall portion 16 from which the inner and outer peripheral wall portions 14 and 15 extend rearwardly. Within the inner peripheral wall portion 14, the pair of right and left chambers 13 are formed respectively on opposite sides of a partition wall 14a serving also as a central side wall of the inner peripheral wall portion 14.

Cantilevered flexible retainers 17 each for retaining the terminal 32 received in the chamber 13 are formed integrally on an inner face of an upper portion of the inner peripheral wall portion 14 of the inner housing 12, and are opposed to the chambers 13, respectively, the flexible retainers 17 extending from the front portion to the rear end. A retaining projection 17a for retaining engagement with a retained portion 33a of the terminal 32 is formed integrally on a lower face of a free end of each flexible retainer 17, and a cancellation projection 17b is formed integrally on a rear portion of the flexible retainer 17 near to the free end thereof. A flexure-allowing space 18 is formed between each flexible retainer 17 and an upper wall of the inner peripheral wall portion 14. A recessed groove 14c serving as a positioning guide portion, is formed in each of opposed side walls 14a and 14b of each chamber 13 in the inner peripheral wall portion 14, and extends horizontally, the groove 14c being disposed substantially centrally of the height of the wall 14a, 14b.

A provisional fitting claw (provisional fitting member) 19a is formed integrally on a lower outer face of the inner peripheral wall portion 14 of the inner housing 12 at a rear portion thereof, and this claw 19a can be engaged in an engagement hole 27, formed in the inner peripheral wall portion 24 of the outer housing 21, to hold the two housings 12 and 21 in a provisionally-fitted condition. A complete fitting claw (complete fitting member) 19b is formed integrally on the lower outer face of the inner peripheral wall portion 14 at a front portion thereof, and this claw 19b can be engaged in the engagement hole 27 in the outer housing 21 to hold the two housings 12 and 21 in a completely-fitted condition.

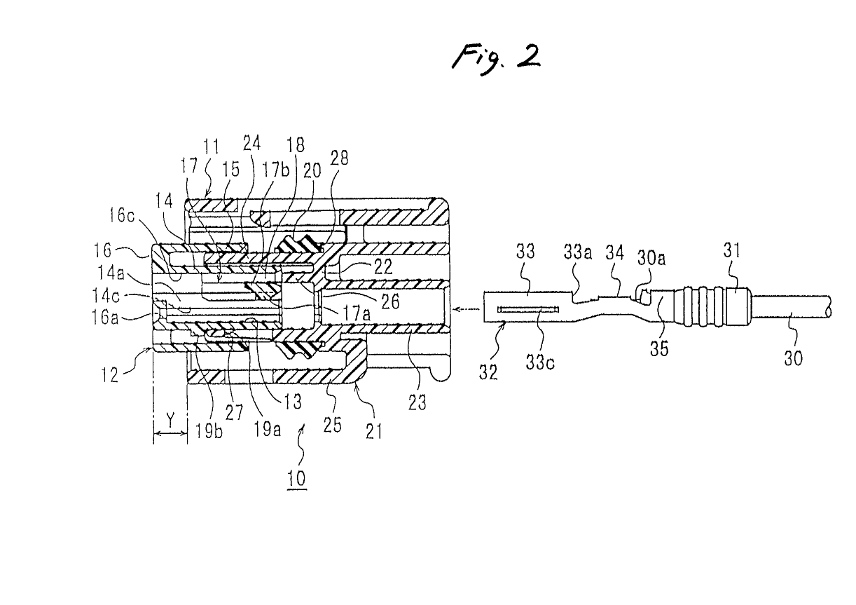

In the above provisionally-fitted condition, when each terminal 32 is inserted into the corresponding insertion path 23 of a substantially cylindrical shape from the rear side thereof, and is received in the corresponding chamber 13, the terminal 32 is retained by the flexible retainer 17. In the provisionally-fitted condition, the front wall portion 16 of the inner housing 12 forwardly projects a predetermined distance from the front side of the outer housing 21 (This projection distance is indicated by reference character Y in FIG. 2). The rubber plug 31, press-clamped by a plug damper 35 formed at a rear end portion of the terminal 32, serves also as a visual confirmation member. When the connector is shifted from the provisionally-fitted condition to the completely-fitted condition, each rubber plug (visual confirmation member) 31 moves into the corresponding insertion path 23, and this movement of the rubber plug 31 can be visually confirmed from the rear side of the outer housing 21 (The amount of movement of each rubber plug 31 is indicated by reference character Z in FIG. 4).

A distal end 15a of the outer peripheral wall portion 15 of the inner housing 12 is formed into a tapering shape, so that when the inner housing 12 and the outer housing 21 are completely fitted together, the distal end 15a of the outer peripheral wall portion 15 of the inner housing 12 and a packing support portion 28, formed on the inner peripheral wall portion 24 of the outer housing 21, hold the waterproof packing 20 therebetween in closely-contacted relation thereto.

Through holes 16a each for passing a mating terminal of a mating connector (not shown) therethrough are formed respectively through those portions of the front wall portion 16 of the inner housing 12 substantially aligned respectively with the chambers 13. A tapering guide face 16b is formed at a front peripheral edge portion of each through hole 16a. Jig insertion holes 16c each for inserting a bar-like terminal-withdrawing jig (not shown) therethrough are formed through the front wall portion 16 of the inner housing 12, and are disposed above the through holes 16a, respectively.

When a distal end portion of the terminal-withdrawing jig is inserted into the jig insertion hole 16c in the same direction as a mating connector-inserting direction, the distal end portion of this terminal-withdrawing jig is brought into abutting engagement with a slanting face of the cancellation projection 17b of the flexible retainer 17 to move the retaining projection 17a upward. More specifically, in the provisionally-fitted condition of the inner and outer housings 12 and 21, the cancellation projection 17b of the flexible retainer 17 is pressed by the distal end portion of the terminal-withdrawing jig, inserted through the jig insertion hole 16c, so that the retaining projection 17a of the flexible retainer 17 is displaced out of engagement with the retained portion 33a of the terminal 32 in the flexure-allowing space 18.

The waterproof packing 20 is made of rubber, and has an annular shape. Front and rear convex portions 20a of a substantially triangular cross-section are formed integrally on the outer peripheral face of the waterproof packing 20. The front and rear convex portions 20a are held between the distal end 15a of the outer peripheral wall portion 15 of the inner housing 12 and the packing support portion 28, formed on the inner peripheral wall portion 24 of the outer housing 21, in closely-contacted relation thereto.

The outer housing 21 includes the pair of insertion paths 23 of a substantially cylindrical shape, integrally formed on and extending rearwardly from a central partition wall 22, the inner peripheral wall portion 24 of a substantially square shape, which is integrally formed on and extends forwardly from the partition wall 22, and serves as a insertion path communicating with the insertion paths 23, and the outer peripheral wall portion 25 of a substantially square shape surrounding the inner peripheral wall portion 24. Thus, the outer housing 21 has a double-wall construction having open front and rear ends. The rubber plug (waterproof plug) 31, which is press-clamped to the terminal 32, and is closely fitted on the wire 30, is inserted into the insertion path 23 by press-fitting or other means. Namely, in the completely-fitted condition of the connector, the rubber plug 31, which is fitted on the wire 30, and is secured to the terminal 32, is held between the wire 30 and the insertion path 23 of a substantially cylindrical shape in closely-contacted relation thereto.

Plate-shaped flexure-preventing members 26 are formed integrally on the partition wall 22 of the outer housing 21, and extend therefrom into the interior of the inner peripheral wall portion 24, and these flexure-preventing members 26 are opposed respectively to the flexure-allowing spaces 18 for the flexible retainers 17 of the inner housing 12. In the completely-fitted condition of the inner and outer housings 12 and 21, each of the flexure-preventing members 26 is inserted in the flexure-allowing space 18 to prevent the flexing (or elastic deformation) of the flexible retainer 17.

The engagement hole 27 is formed through the lower wall of the inner peripheral wall portion 24 of the outer housing 21, and the provisional fitting claw 19a and the complete fitting claw 19b, formed on the inner peripheral wall portion 14 of the inner housing 12, can be releasably engaged with this engagement hole 27. A tapered packing support portion 28 is formed integrally at the proximal end of the inner peripheral wall portion 24 of the outer housing 21 at which the partition wall 22 is provided. The tapered face is so formed as to be along with a surface of the convex portion 20a of the annular waterproof packing 20 of rubber.

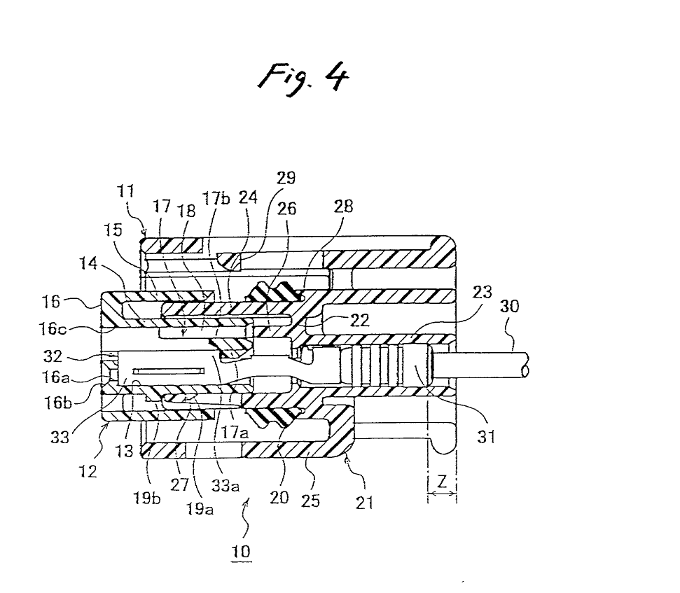

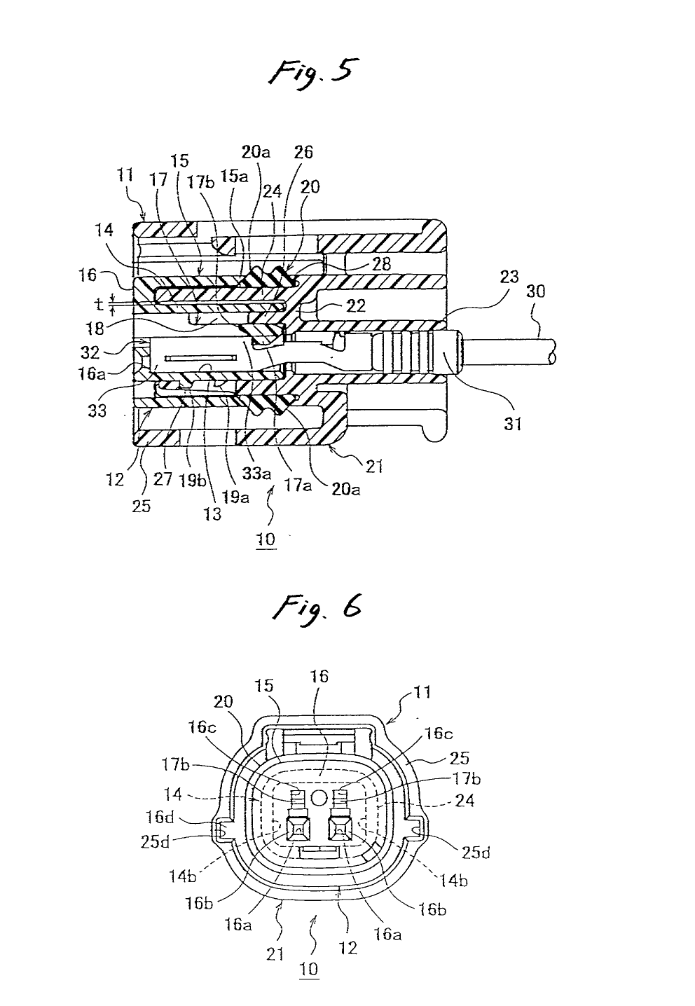

Recesses 25d for respectively guiding convex portions, formed respectively on opposite sides of the mating connector (not shown), are formed respectively in inner faces of the opposite side walls of the outer peripheral wall portion 25 of the outer housing 21, each of the recesses 25d being disposed substantially centrally of the height of the side wall. A retaining hole 29 is formed through a front portion of the upper wall of the outer peripheral wall portion 25 of the outer housing 21, and an elastic retaining arm on the mating connector (not shown) is releasably engageable in this retaining hole 29. In an assembled condition of the inner and outer housings 12 and 21, a clearance t is formed between the inner peripheral wall portion 14 of the inner housing 12 and the inner peripheral wall portion 24 of the outer housing 21, as shown in FIG. 5.

As shown in FIGS. 1, 2, 7 and 8, the terminal 32 has a female terminal body 33 of a square tubular shape, and convex portions 33c, each serving as a positioning member, are integrally formed respectively on opposite side faces of the terminal body 33, and extend horizontally, each of the convex portions 33c being disposed substantially centrally of the height of the side face. The convex portions 33c are engaged respectively in the grooves 14c, formed respectively in the opposed side walls of the chamber 13, thereby properly positioning the terminal 32 received in the chamber 13. When the terminal is thus received in the chamber, the upper edge (retained portion) 33a of the rear end of the terminal body 33, which serves as the retaining portion, is retained by the retaining projection 17a of the flexible retainer 17. A conductor 30a of the wire 30 is press-clamped by a conductor damper 34 of the terminal 32, and the front end portion of the rubber plug 31 is press-clamped by the plug clamper 35 of the terminal 32.

For assembling the connector 10 of this embodiment, the waterproof packing 20 is fitted in the packing support portion 28 of the inner peripheral wall portion 24 of the outer housing 21 forming the outer portion of the connector housing 11, as shown in FIG. 2. Then, the inner peripheral wall portion 14 of the inner housing 12, forming the inner portion of the connector housing 11, is fitted into the inner peripheral wall portion 24 of the outer housing 21, and the provisional fitting claw 19a, formed on the inner peripheral wall portion 14 of the inner housing 12, is engaged with the engagement hole 27 in the inner peripheral wall portion 24 of the outer housing 21, thereby provisionally fitting the inner housing 12 in the outer housing 21. In this provisionally-fitted condition, the front wall portion 16 of the inner housing 12 forwardly projects a distance Y from the outer housing 21.

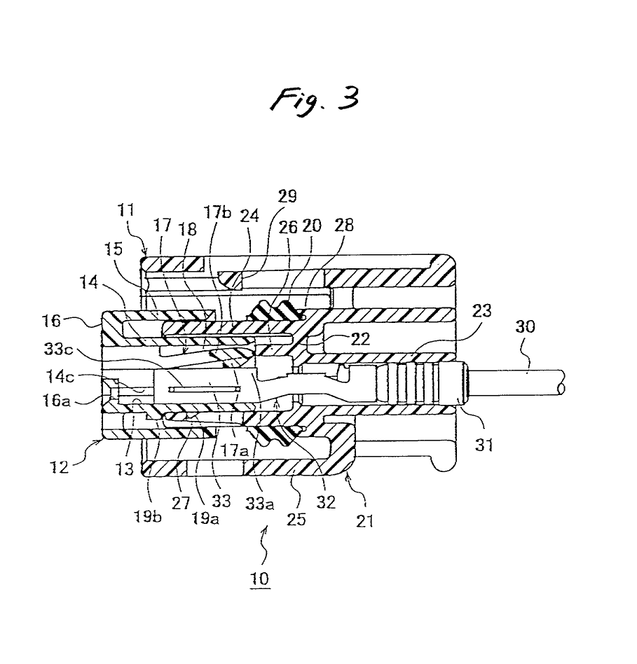

Then, in the provisionally-fitted condition, when each terminal 32, press-clamping the wire 30 and the rubber plug 31, is inserted into the insertion path 23 in the outer housing 21, and is received in the chamber 13 in the inner housing 12 as shown in FIG. 3, the rear upper edge 33a of the terminal body 33 of the terminal 32 is retained by the retaining projection 17a of the flexible retainer 17 as shown in FIG. 4, so that the terminal 32 is primarily retained by the flexible retainer 17.

Here, the rear end portion of the rubber plug 31 is pulled into the insertion path 23 by a distance Z from the rear end face of the outer housing 21. The distance Z is so selected as to become smaller than the distance Y.

Then, when the inner peripheral wall portion 14 of the inner housing 12 is further fitted into the inner peripheral wall portion 24 of the outer housing 21 as shown in FIG. 5, the complete fitting claw 19b, formed on the inner peripheral wall portion 14 of the inner housing 12, is retainingly engaged in the engagement hole 27 in the inner peripheral wall portion 24 of the outer housing 21, and the inner housing 12 is completely fitted in the outer housing 21, thus completing the assembling of the connector 10.

In accordance with the fitting operation of the inner housing 12, the terminal 32 and the rubber plug 31 are moved backwards within the insertion path 23. Since the distance Z is so selected as to become the distance Y, the rear end portion of the rubber plug 31 is projected outside from the rear end face of the outer housing 21, when the inner housing 12 is in the completely-fitted condition.

When the inner housing 12 is completely fitted into the outer housing 21, each flexure-preventing member 26 of the outer housing 21 is inserted into the flexure-allowing space 18 for the flexible retainer 17 of the inner housing 12. As a result, the flexure-preventing member 26 positively prevents the flexible retainer 17, primarily retaining the terminal 32, from being elastically deformed away from the terminal 32. Therefore, the terminal 32 is retained by the retaining projection 17a of the flexible retainer 17, and also is indirectly retained by the flexure-preventing member 26 which prevents the elastic deformation of the flexible retainer 17. Thus, each terminal is easily and positively retained in a double manner.

The completion of the double-retaining of each terminal 32 by the flexible retainer 17 of the inner housing 12 and the flexure-preventing member 26 of the outer housing 21 can be easily confirmed from the rearward movement (i.e., the movement over the distance Y in FIG. 2) of the inner housing 12 at the front side of the outer housing 21 at the time of shifting of the inner housing 12 from the provisionally-fitted condition to the completely-fitted condition, and also from the rearward movement (i.e., the movement over a distance Z in FIG. 4) of the rubber plug 31 in the substantially-cylindrical insertion path 23 at the rear portion of the outer housing 21

Namely, the rearward movement of the inner housing 12 at the front side of the outer housing 21 at the time of shifting of the inner housing 12 from the provisionally-fitted condition to the completely-fitted condition and the rearward movement of the rubber plug 31 (occurring simultaneously with the above rearward movement of the inner housing 12) in the substantially-cylindrical insertion path 23 at the rear portion of the outer housing 21 can be confirmed at the front and rear sides of the connector housing 11, respectively. Therefore, in a wire harness-producing process, the movement of the operator for inspection and confirmation purposes is much less as compared with the related construction, and the efficiency of the operation is much enhanced.

When the inner housing 12 and the outer housing 21 are completely fitted together, the slanting face of the distal end 15a of the outer peripheral wall portion 15 of the inner housing 12 and the packing support portion 28 hold the waterproof packing 20 therebetween in closely-contacted relation thereto. In this completely-fitted condition, the rubber plug 31, which is fitted on the wire 30, and is secured to the terminal 32, is received in the insertion path 23 in the outer housing 21 in closely-contacted relation thereto. With these effects, the waterproof performance of the assembled connector 10 is much enhanced.

Thus, in the completely-fitted condition of the inner housing 12 and the outer housing 21, the convex portions 20a and 20b of the waterproof packing 20, made of rubber, are disposed between and held in intimate contact respectively with the slanting surface of the distal end 15a of the outer peripheral wall portion 15 of the inner housing 12 and the packing support portion 28 of a V-shaped cross-section formed at the proximal end of the inner peripheral wall portion 24 of the outer housing 21. Therefore, vibrations, applied to the outer housing 21, can be absorbed by the waterproof rubber packing 20.

As shown in FIG. 8, the convex portions 33c are integrally formed respectively on the opposite side surfaces 33b of the terminal body 33 of the terminal 32, and the grooves 14c of a channel-shaped cross-section, in which the convex portions 33c can be engaged, respectively, are formed respectively in the opposed side walls 14a and 14b of each chamber 13 (which are to be opposed respectively to the convex portions 33c) in the inner housing 12, and thanks to the provision of the convex portions 33c and the grooves 14c, the clearance of the terminal 32 in the chamber 13 is reduced. Namely, as shown in FIG. 8, the clearance (Δd′) of the terminal 32 is formed as a result of accumulation of dimensional irregularities (tolerances) of two dimensions, that is, a height A′ from the bottom surface of the chamber 13 to the upper surface of each groove 14c and a height B′ from the bottom surface of the terminal body 33 of the terminal 32 to the upper surface of each convex portion 33c (Δd′=A′−B′), and therefore the durability against vibrations and others is enhanced. Therefore, wear of that portion of the terminal 32, disposed in contact with the mating terminal, which would be caused by the clearance, is positively prevented, so that the contact reliability of the terminal 32 is further enhanced.

The convex portions 33c are integrally formed respectively on the opposite side surfaces 33b of the terminal body 33, and the grooves 14c of a channel-shaped cross-section are formed respectively in the opposed side walls 14a and 14b of each chamber 13, and with these simple configurations, the clearance of the terminal 32 in the chamber 13 is suppressed easily and positively, and the connector 10 of a high reliability can be produced at low costs.

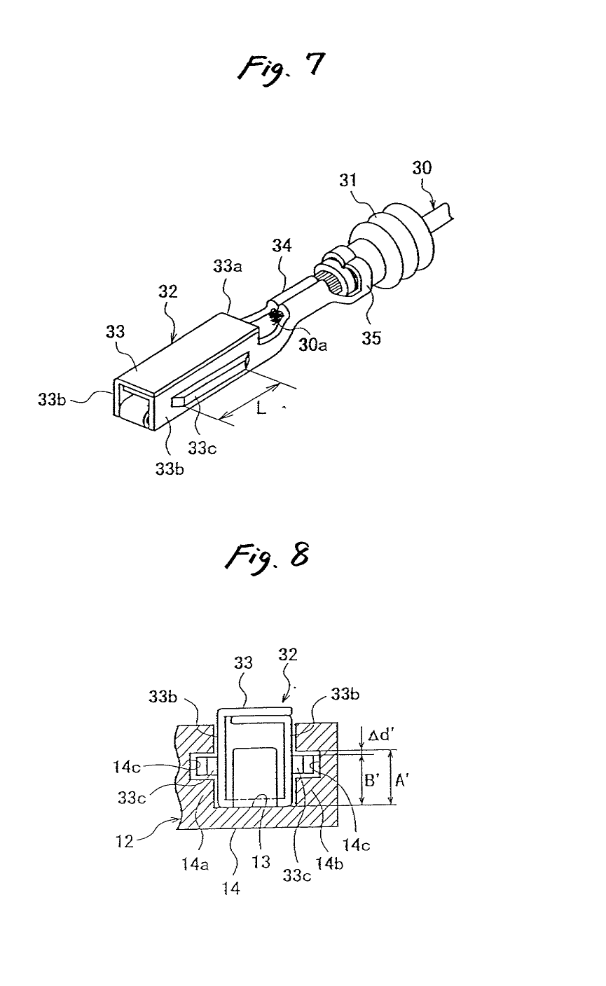

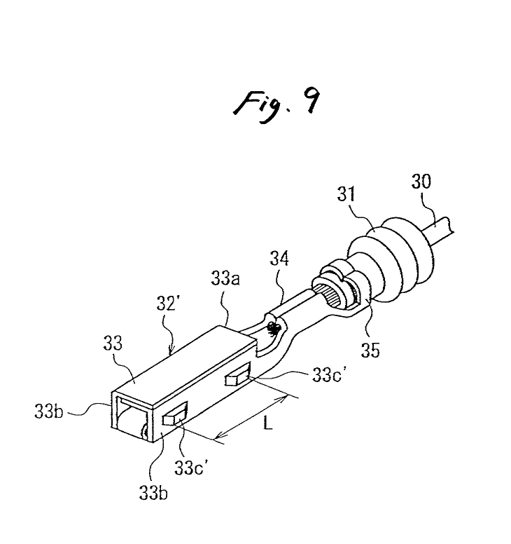

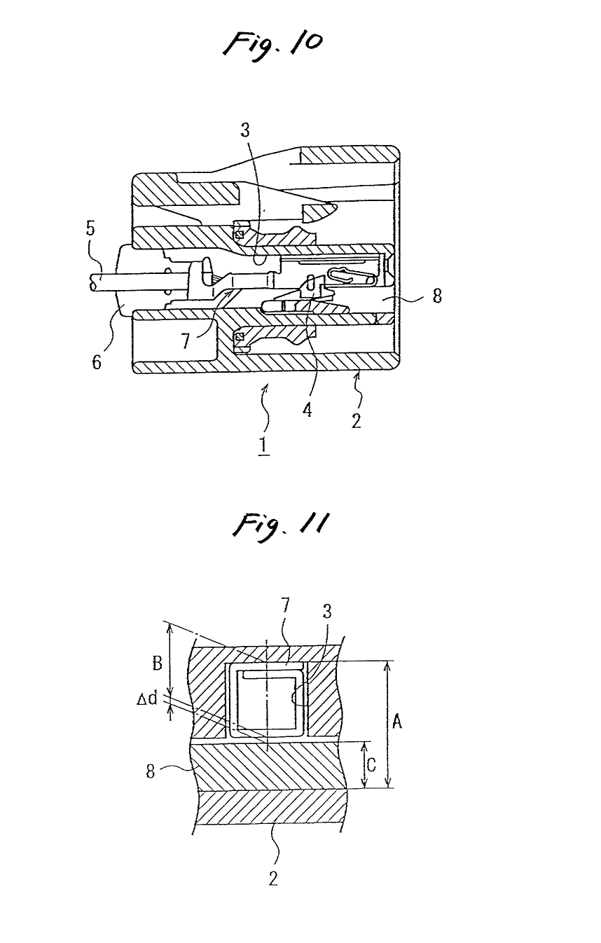

In the above embodiment, as shown in FIG. 7, the convex portions 33c are integrally formed respectively on the opposite side surfaces 33b of the terminal body 33 of the terminal 32 by pressing or the like, and extend horizontally over a predetermined span L entirely. However, as shown in FIG. 9, a pair of discrete convex portions 33c′ may be integrally formed respectively on front and rear portions of each side surface 33b of a terminal body 33 of a terminal 32 in such a manner that the span of the two discrete convex portions 33c′ constitutes both ends of the span L. Although the terminals, each press-clamping the rubber plug at its rear end portion, are used, there may be used the type of terminals to which a rubber plug is not press-clamped, in which case the rubber plug is mounted on the wire.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A connector comprising;
a terminal fitting, connected to an electric wire;
at least one pair of positioning members, provided on both side faces of the terminal fitting; and
a housing, including a chamber for accommodating the terminal fitting therein, and a pair of guide members engaged with the associated positioning members to guide the terminal fitting inserted into the chamber to a predetermined position.

2. The connector as set forth in claim 1, wherein the positioning members are protrusions integrally formed with the both side walls of the terminal fitting; and
wherein the guide members are a pair of grooves each formed on both side walls of the chamber for receiving the associated protrusions therein.
